(19) United States
(12) Patent Application Publication
(10) Pub. No.: US 2019/0366655 A1
(43) Pub. Date: Dec. 5, 2019

(54) COMPOSITE ELASTIC MATERIAL FOR MODELING AND METHOD FOR MANUFACTURING THE SAME

(71) Applicant: OBSHCHECTVO S OGRANICHENNOJ OTVETSTVENNOSTYU "NOVAYA KHIMIYA", Tomsk (RU)

(72) Inventors: Anastasiya Georgievna EREMINA, Tomsk (RU); Igor Vladimirovich KOVALEV, Tomsk (RU); Dmitrij Yurevich STARODUBTSEV, Tomsk (RU); Anna Konstantinovna TRUSHINA, Tomsk (RU); Yuliya Sergeevna MATYASH, Tomsk (RU)

(21) Appl. No.: 16/481,214

(22) PCT Filed: May 3, 2018
(86) PCT No.: PCT/RU2018/000282

§ 371 Date: Jul. 26, 2019

(30) Foreign Application Priority Data
May 29, 2017 (RU) 2017118654

(51) Int. Cl. B29C 70/66; C08L 83/06; C08K 7/28; C08L 25/06; C08L 27/06

(52) U.S. Cl. CPC B29C 70/66; C08L 83/06; C08L 2312/00; C08L 25/06; C08L 27/06; C08K 7/28

(57) ABSTRACT

A composite elastic material comprises a bulk polymer material having fractions from 0.005 to 0.1 mm with fraction homogeneity of 10 to 100% which is presented by a granular fine dispersed bulk polymer material, a binding substance in the form of an agent with OH-groups in an amount of 10 to 50% by weight of the bulk polymer material, a crosslinking agent in an amount of 0.5 to 10% by weight of the agent with OH-groups, and a plasticizing agent in an amount of 0.02 to 2% by weight of the agent with OH-groups. To obtain the composite material, a binding substance is obtained by crosslinking the agent with OH-groups, plasticizing and distributing it over the volume of the bulk material, and fixing the binding substance on the surface of the bulk material.

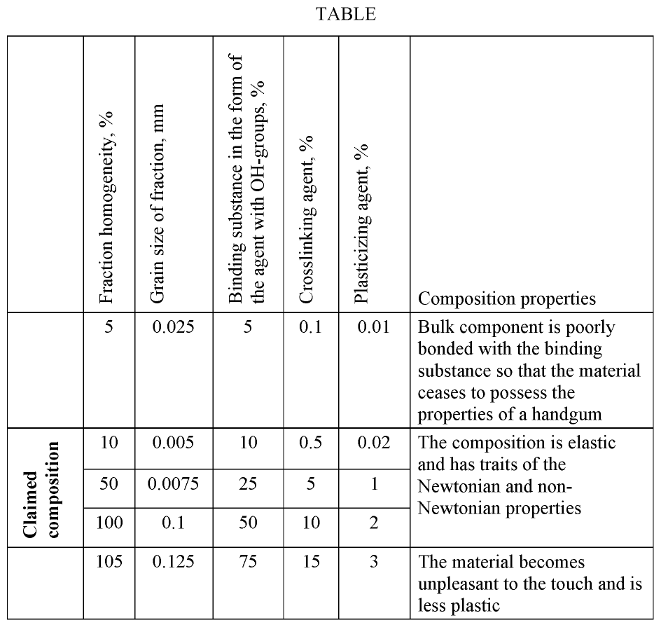

This nonprovisional application is a continuation of International Application No. PCT/RU2018/000282, which was filed on May 3, 2018, and which claims priority to Russian Patent Application No. RU 2017118654, which was filed in Russia on May 29, 2017, and which are both herein incorporated by reference.

### FIELD OF THE INVENTION

The present invention can be used for children's creativity, games, training, modeling, and development of fine motor skills.

### BACKGROUND OF THE INVENTION

A method for preparing masses for modeling with biocidal properties is known (patent RU 2473216 IPC A01N25/00 publ. 27 Mar. 2013), which method comprises mixing organosiloxane, boric acid, and Lewis acid together, heating of the resulting mixture, and adding a biocidal additive and at least one additive selected from a group including filler, pigment, and plasticizer. Boric acid is used in an amount of 4-40 parts by weight (wt. parts) per 100 wt. parts of organosiloxane, Lewis acid is used in an amount of 0.001-3 wt. parts per 100 wt. parts of organosiloxane, and silver nanoparticles are used as a biocidal additive in an amount of 0.00001-0.1 wt. parts per 100 wt. parts of organosiloxane.

A disadvantage of the known technical solution is the use of expensive silver nanoparticles and Lewis acid, which complicates the synthesis, and, consequently, the technological process and also increases its cost.

An air clay is known (patent KR 10-0874091 IPC A21D8/00 publ. 16 Dec. 2008) comprising a basic substance, such as finely ground sand powder, and glycerol, which air clay has a texture and characteristics significantly different from the texture and characteristics of traditional adhesive sands or artificial clays and can be reused without water. When pulling, the clay stretches, absorbs air, and thus becomes loose and soft, like a cloud, cotton or snow. When conglomerating the clay by compressing, it releases air and becomes dense and solid. Because of their nature, these sands solve some problems and overcome limitations of traditional adhesive sand or artificial clay.

A disadvantage of the air clay is that finely ground sand powder is selected as the base substance, thus the finished product will be heavier, not suitable for baking in the oven, not capable to float on water, and also have the property of jumping (i.e. jumping like a ball when hitting a hard surface).

Non-hardening clay composition and method for manufacturing the same are known (patent EP 2458576 publ. 30 May 2012), which composition comprises 100 wt. parts of diatomite powder (the first base material) ground to a grain size of 10 to 10,000 mesh and from 5 to 70 wt. parts of amphiprotic (hydrophilic and lipophilic) fluid. Additionally, the composition comprises from 10 to 100 wt. parts of a second base material, which is selected as one or more materials from a group consisting of sand, shells, quartz sand, red clay, white clay, cereals, hard shells of nuts, coconut substrate and sawdust, and has a grain size equivalent to or smaller than 1/10 of the diatomite powder. Said diatomite powder and fluid are sufficiently mixed and kneaded so that the fluid passes through pores of the diatomite powder and is dispersed therein.

A disadvantage of the composition and method is that the resulting product has a narrow set of properties and is used only as a mass for modeling with the possibility of baking the molded figure in the oven.

Plastic silicone composition is known (patent RU 2612677 IPC C08L 83/04 publ. 13 Mar. 2017) comprising non-toxic powdery mineral component having a grain size of 0.01-1.0 mm, polydimethylsiloxane, an alkaline solution with pH 12-14, a crosslinking agent and a plasticizer.

A disadvantage of this technical solution is that the alkaline solution is used in the technological process, which imposes restrictions with regard to safety engineering and makes production process dangerous. Additionally, the finished product has a narrow set of properties, being a crumbly plastic mass that is not suitable for baking in the oven, so that molded figures do not hold their shape for a long period of time (due to spreading under their own weight), can not float on water, and do not jump like a ball when hitting a hard surface, etc.

### SUMMARY OF THE INVENTION

The technical challenge is expanding the range of tools available.

The present invention has been made in view of the above-mentioned drawbacks, whereupon the technical result of the present invention is obtaining a safe composition that combines the properties of Newtonian and non-Newtonian fluids, polymer clay, plasticine, kinetic sand, and handgum and developing a method for manufacturing said composition.

The technical result according to the first aspect of the invention is achieved by the fact that the composite elastic material comprises a bulk polymer material having fractions of 0.005 to 0.1 mm with fraction homogeneity of 10 to 100% which is presented by a granular finely dispersed bulk polymer material, a binding substance in the form of an agent with OH-groups in an amount of 10 to 50% by weight of the bulk polymer material, a crosslinking agent in an amount of 0.5 to 10% by weight of the agent with OH-groups, and a plasticizing agent in an amount of 0.02 to 2% by weight of the agent with OH-groups.

As the bulk polymer material, finely dispersed polyvinyl chloride granules, and also expanded finely dispersed granules of polystyrene or perlite can be used.

As the bulk polymer material, a mixture of the bulk polymer material and quartz microspheres in a ratio of 80:20 can be used, and also a mixture of the bulk polymer material and quartz flour in a ratio of 70:30.

As the agent with OH-groups, OH-terminated polydimethylsiloxane having a viscosity of 50 to 10,000 cps, silicone rubber, or siloxanes containing OH-groups can be used.

Boron-containing compounds are used as the crosslinking agent, for example, boric alcohol (boric acid alcohol solution).

Luminophors 0.1-50%, decorative inclusions 0.001-50%, and flavors 0.00001-5% by weight of the bulk polymer material may be added to the composite elastic material.

The technical result according to the second aspect of the invention is achieved by the fact that the method for manufacturing a material includes obtaining a binding substance by crosslinking an agent with OH-groups, plasticizing and distributing it over the volume of a bulk material, fixing the binding substance on the surface of the bulk material, wherein the following are added in stages to the agent with OH-groups having a viscosity of from 1000 to 1500 cps in an amount of from 10 to 50% in the reactor for mixing the components, by weight of the agent with OH-groups: a crosslinking agent in an amount of 0.5 to 10% and a plasticizing agent in an amount of 0.02 to 2%; wherein the components are mixed for no more than 10-15 s at a mixing rate of 150-200 rpm at each stage, provided that the overall time of adding and mixing the components is no more than 40-60 s, then obtained binding substance is poured into the bulk polymer material, the resulting mass is mixed so that the binding substance is applied on the bulk material until the binding substance is uniformly distributed over the whole volume of the bulk material; to fix the binding substance, the mass is spread in a layer of 0.1 to 50 cm in thickness in air and left under normal conditions until completely dry.

When mixing, the components of the binding substance can be heated to 80° C., and also the binding substance and the bulk material can be mixed at 50° C. Additionally, the bulk polymer material and the binding substance may be colored.

### BRIEF DESCRIPTION OF THE DRAWINGS

Embodiments of the invention are illustrated by the FIGURE that shows a table illustrating the rationale for the claimed composition ratios.

### IMPLEMENTATION OF THE INVENTION

The composite material manufacturing process takes place in three stages. At the first stage, the binding substance is prepared:
for example, OH-terminated polydimethylsiloxane having a viscosity of 1000 to 1500 cps is taken in an amount of 20 to 27% by weight having a viscosity of 1000 to 1500 cps is taken in an amount of 20 to 27% by weight of the bulk material and a crosslinking agent is dissolved in an amount of 1 to 20% by weight of the agent with OH-groups. Water, ethyl alcohol and other alcohols capable to dissolve or partially dissolve the crosslinking agent can be used as a solvent. The solvent is used to more uniformly distribute the crosslinking agent over the volume of the agent with OH-groups, and also serves as an inhibitor of the crosslinking reaction, which proceeds fairly quickly;
the following are added, by weight of OH-terminated polydimethylsiloxane: fatty acid (for example, oleic acid) in an amount of 0.02 to 0.08%, trihydric alcohol (for example, glycerol) in an amount of from 0.08 to 2%, boron-containing compound, for example, boric acid in an amount of 2 to 4%. The process of adding components to OH-terminated polydimethylsiloxane is divided into the stages. Each stage takes place in the reactor for mixing the components and lasts for no more than 10-15 s at a mixing rate of 150-200 rpm. The overall time of adding and mixing the components is not more than 40-60 s.

At the second stage, the binding substance is applied on the bulk polymer material:
fraction of 0.01 to 0.063 mm of finely dispersed polyvinyl chloride granules with fraction homogeneity of 75 to 95% is poured into the reactor tank for mixing the bulk materials and viscous solutions together;
the binding substance is pour out, then the mass is mixed until the binding substance is uniformly distributed over the whole volume of the bulk polymer material.

At the third stage, the binding substance is fixed on the surface of the bulk material:
the resulting mixture of the bulk polymer material and the binding substance is spread in a layer of 0.1 to 50 cm in thickness in air and left under normal conditions until completely dry. Composition layer height of more than 50 cm increases the drying time, since the resulting product evaporates excess moisture to reach its final state, while drying of a layer with a height of less than 0.1 cm is technologically impracticable.

The bulk polymer material can be pre-colored. Coloring is carried out with polymer, synthetic, mineral, food dyes or pigment of any color with different degrees of color saturation. A dye or pigment is used in powder, gel, liquid, and other forms and any proportions depending on the nature of the dye/pigment.

Finely dispersed expanded polystyrene granules can be used as the bulk polymer material, whereupon the finished product becomes lighter and can float on water for a much longer amount of time. To impart a glow-in-the-dark property to the elastic material, a luminophor is added to the binding substance and/or to the bulk material. To impart a sparkling property to the elastic material, decorative inclusions are added to the binding substance and/or to the bulk material. To provide the elastic material with a pleasant flavor, flavoring materials are added to the binding substance and/or to the bulk material.

### EXAMPLES OF SPECIFIC IMPLEMENTATION

### Example 1

The following were added to OH-terminated polydimethylsiloxane having a viscosity of 1200 cps in an amount of at least 20% by weight of the bulk material, by weight of OH-terminated polydimethylsiloxane: oleic acid in an amount of 0.06%, glycerol in an amount of 1%, and boric acid in an amount of 3% pre-moistened with ethyl alcohol (7% by weight of OH-terminated polydimethylsiloxane).

Components were added to OH-terminated polydimethylsiloxane in stages. The components were mixed in the reactor for no more than 15 seconds at a mixing rate of 150 rpm at each stage. The overall time of adding and mixing the components was not more than 60 seconds. Then 0.01 mm fraction of finely dispersed polyvinyl chloride granules with fraction homogeneity of 95% was poured into the reactor tank for mixing the bulk components and viscous solutions together, the binding substance was poured out, and then the mass was mixed until the binding substance was uniformly distributed over the whole volume of the bulk polymer material. The resulting mixture of the bulk polymer material and the binding substance was spread in a layer of 10 cm in thickness in air and left under normal conditions until completely dry.

### Example 2

The following were added to OH-terminated polydimethylsiloxane having a viscosity of 1000 cps in an amount of 27% by weight of the bulk material, by weight of OH-terminated polydimethylsiloxane: oleic acid in an amount of 0.02%, glycerol in an amount of 1.5%, boric acid in an amount of 2% pre-moistened with water (10% by weight of OH-terminated polydimethylsiloxane).

Components were added to OH-terminated polydimethylsiloxane in stages. At each stage, the components were mixed in the reactor for no more than 10 s at a mixing rate of 200 rpm. The overall time of adding and mixing the components was not more than 40 seconds. Then 0.04 mm fraction of finely dispersed expanded polystyrene granules with fraction homogeneity of 75% was poured into the reactor tank for mixing the bulk components and viscous solutions together, a food dye previously dissolved in water (5% by weight of expanded polystyrene) was added in an amount of 0.1% by weight of the bulk material (expanded polystyrene), the binding substance was poured out, and the mass was mixed until the binding substance was uniformly distributed over the whole volume of the bulk polymer material. The resulting mixture of the bulk polymer material and binding substance was spread in a layer of 10 cm in thickness in air and left under normal conditions until completely dry.

The resulting material has the properties of Newtonian and non-Newtonian substances. In its original state, it is a taut mass, which in the case of an abrupt physical impact becomes even harder and breaks into pieces.

With mild impact, it becomes soft and stretches well. When rolling into a spherical form, it jumps like a ball. During the game, it gets warm from the hands and gets saturated with moisture from the palms of hands and becomes soft and fluffy (very gentle and light, as if a cloud with cotton wool was mixed), increasing in volume 3-4 times, so that the rolled spherical form does not longer jump like a ball. When spreading the material in the form of pancake (as flat as possible), it cools down to ambient temperature for a few hours, evaporates moisture from the hands and acquires the non-Newtonian properties again, i.e. it becomes taut and highly elastic.

Additionally, the elastic material can be molded into figure and baked in an oven at 180° C., wherein baking time depends on the size of the figure. The figure will harden and become solid in the given shape. Molded figures can float on water (they do not sink or lose their properties).

Having the claimed combination of features (table), composition becomes elastic and gets traits of the Newtonian and non-Newtonian properties.

The provided method is simple, since the manufacturing process does not require the use of vacuum, high temperatures, harmful/toxic solvents, flammable substances, expensive catalysts based on noble metals, active acids and alkalis. The manufacturing process of the product can be carried out without exhausting system, since this process uses neither volatile substances nor boiling stage.

The finished product contains an antiseptic agent that prevents bacterial formation and growth.

It should also be understood that the composition and method disclosed in the materials of the present description, in fact, are exemplary and these specific embodiments should not be understood in a restrictive sense, indeed, numerous variants are possible.

The object of the present description includes all new and non-obvious combinations and sub-combinations of various compositions and methods disclosed in the materials of the present description.

1. A composite elastic material comprising a bulk polymer material having fractions from 0.005 to 0.1 mm with fraction homogeneity of 10 to 100% which is presented by a granular finely dispersed bulk polymer material, a binding substance in the form of an agent with OH-groups in an amount of 10 to 50% by weight of the bulk polymer material, a crosslinking agent in an amount of 0.5 to 10% by weight of the agent with OH-groups, and a plasticizing agent in an amount of 0.02 to 2% by weight of the agent with OH-groups.

2. The composite elastic material according to claim 1, wherein finely dispersed polyvinyl chloride granules are used as the bulk material.

3. The composite elastic material according to claim 1, wherein finely dispersed expanded polystyrene granules are used as the bulk polymer material.

4. The composite elastic material according to claim. 1, wherein finely dispersed expanded perlite granules are used as the bulk polymer material.

5. The composite elastic material according to claim 1, wherein quartz microspheres are added to the bulk polymer material in a ratio of 20:80.

6. The composite elastic material according to claim 1, wherein quartz flour is added to the bulk polymer material in a ratio of 30:70.

7. The composite elastic material according to claim 1, wherein OH-terminated polydimethylsiloxane having a viscosity of 50 to 10,000 cps is used as the agent with OH-groups.

8. The composite elastic material according to claim 1, wherein silicone rubber is used as the agent with OH-groups.

9. The composite elastic material according to claim 1, wherein siloxanes containing OH-groups are used as the agent with OH-groups.

10. The composite elastic material according to claim 1, wherein boron-containing compounds are used as the crosslinking agent.

11. The composite elastic material according to claim 1, wherein said material additionally comprises luminophors in an amount of 0.1 to 50% by weight of the bulk polymer material.

12. The composite elastic material according to claim 1, wherein said material additionally comprises decorative inclusions in an amount of 0.001 to 50% by weight of the bulk polymer material.

13. The composite elastic material according to claim 1, wherein said material additionally comprises flavoring materials in an amount of 0.00001 to 5% by weight of the bulk polymer material.

14. The composite elastic material according to claim 1, wherein said material additionally comprises thermochromic dyes in an amount of 0.001-5% by weight of the bulk polymer material.

15. The composite elastic material according to claim 1, wherein colored bulk polymer materials are used.

16. A method for manufacturing a composite elastic material, the method comprising:
obtaining a binding substance by crosslinking an agent with OH-groups;
plasticizing and distributing the binding substance over the volume of a bulk material;
fixing the binding substance on the surface of the bulk material, wherein the following are added in stages to the agent with OH-groups having a viscosity from 1000 to 1500 cps in an amount of 10 to 50% in the reactor for mixing the components, by weight of the agent with OH-groups: a crosslinking agent in the amount of 0.5 to 10% and a plasticizing agent in the amount of 0.02% to 2%; wherein the components are mixed for no more than 10-15 seconds at a mixing rate of 150-200 rpm at each stage, provided that the overall time of adding and mixing the components is no more than 40-60 seconds;
pouring the obtained binding substance into the bulk material;
mixing the obtained binding substance with the bulk material so that the binding substance is applied on the bulk material until the binding substance is uniformly distributed over the whole volume of the bulk material;
spreading a mixture of the binding substance and the bulk material for fixing the binding substance in a layer of 0.1 to 50 cm in thickness; and
drying the mixture in air under normal conditions.

17. The method according to claim 16, wherein the binding substance and the bulk material are heated to about 50° C. to about 80° C. during mixing.

18. (canceled)

19. The method according to claim 16, wherein convection of air masses is used to fix the binding substance.

20. The method according to claim 16, wherein the bulk polymer material is colored.

21. The method according to claim 16, wherein the binding substance is colored.
